(19) United States
(12) Patent Application Publication
(10) Pub. No.: US 2020/0233377 A1
(43) Pub. Date: Jul. 23, 2020

(54) MARKING METHOD AND SYSTEM

(71) Applicant: RENISHAW PLC, Wotton-under-Edge, Gloucestershire (GB)

(72) Inventors: Nicholas John WESTON, Peebles (GB); Duncan Paul HAND, Edinburgh (GB); Krystian Lukasz WLODARCZYK, Edinburgh (GB)

(73) Assignee: RENISHAW PLC, Wotton-under-Edge, Gloucestershire (GB)

(21) Appl. No.: 16/652,081

(22) PCT Filed: Oct. 16, 2018
(86) PCT No.: PCT/GB2018/052969

§ 371 Date: Mar. 30, 2020

(30) Foreign Application Priority Data
Oct. 17, 2017 (GB) 1717039.0

(51) Int. Cl. G03H 1/00; G03H 1/08; G03H 1/30

(52) U.S. Cl. CPC G03H 1/0011; G03H 1/0808; G03H 1/0841; G03H 1/0891; G03H 2240/12; G03H 2001/0016; G03H 2001/0816; G03H 2240/11; G03H 1/30

(57) ABSTRACT

A method and system for forming a holographic structure in a material. The holographic structure is configured to project a selected target image in the far field under illumination of the holographic structure by a laser. The method calculates a modified design for the holographic structure that encodes a unique identifier within the holographic structure for projecting the target image. The method modifies the material by mapping features corresponding to the modified design into the material so as to form the holographic structure. A basic check of the authenticity of the material is performed by checking whether a projected replica of the target image is as expected. A more detailed check of the authenticity of the material is performed by directly inspecting the features in the holographic structure.

### FIELD

The present disclosure relates to a method and system for marking a material for, particularly but not exclusively, preventing counterfeiting.

### BACKGROUND

Products such as electronics goods, mechanical components, and the like may be marked with a unique identification such as a serial number to provide authentication of the product and to allow the product to be traced during distribution.

Common methods for marking products include etching or sticking serial numbers, barcodes, 2D codes or the like onto products. These methods can be replicated to mark counterfeit products with a unique identification that at first glance appears genuine. Another method involves attaching a holographic sticker including a unique identification to a product. Holographic techniques are considered to be relatively sophisticated and difficult to replicate. However, counterfeiters are becoming increasingly sophisticated and may be capable of replicating holographic stickers for attaching to counterfeit products.

### SUMMARY

According to a first independent aspect there is provided a method for forming a holographic structure in a material, the holographic structure being configured to project a target image in the far field under illumination of the holographic structure, the method comprising:

calculating a design for the holographic structure for projecting the target image;

modifying the design to encode an identifier within the holographic structure for projecting the target image; and

modifying the material by mapping features corresponding to the modified design into the material.

In use, the holographic structure formed by the method may be used as a security marking such as for reducing the likelihood of counterfeiting of a product marked with the holographic structure. Illuminating the holographic structure (e.g. using coherent radiation such as may be produced by a laser, or the like) may project the target image in the far field. The target image may be selected according to a user or manufacturer specification, or the like. The target image may comprise any image, such as a serial number, unique code, part number, signature, logo, image, photo, name, brand, code, symbol, set of characters, or the like. Upon being illuminated by radiation, the holographic structure may diffract the radiation such that an image is formed in the far field, which may correspond to a replica of the target image. The replica of the target image may be an approximation of the target image. The holographic structure may contain sufficient information (e.g. the number of features may correspond to the amount of information) to approximately form the replica of the target image in the far field. The number, size, density, distribution and/or position, or the like, of the features, and/or the properties of the radiation illuminating the holographic structure may at least partially define how closely the replica of the target image corresponds to the target image itself.

The projected target image may comprise one or more images which may be due to 1st or higher order diffractive effects and/or symmetry in the holographic structure as well as the 0th order reflection and/or transmission from the illuminated features. The method may be used to insert an identifier, for example a unique or hidden identifier, into the holographic structure that may only be identifiable upon inspection of the holographic structure itself rather than of the projected target image. The modified design for the holographic structure may project a target image that is indistinguishable from, or at least similar to, the target image projected by a holographic structure corresponding to the unmodified design.

An end user, manufacturer, dealer, distributer, a counterfeiter, or the like, may perform a basic test of the authenticity of a material or product comprising the holographic structure by projecting the target image using a laser, or the like from the holographic structure. However, in this situation it may not be apparent that the holographic structure may contain the identifier. Only a user such as the manufacturer of the product or other authorised users with knowledge of the identifier, as well as the appropriate equipment for checking the holographic structure, may be able to determine whether or not a product is genuine.

It will be appreciated that the term “material” may refer to a material, product, product comprising the material, or the like. Any reference to “material” may also refer to a product, product comprising the material, or the like. The method may be used to modify a product directly, and/or may be used to modify a material or other product for attaching to another product or material. Since the holographic structure may be directly applied to the product or material, the holographic structure may be relatively tamper-proof, versatile, and/or relatively easy to apply to the product or material.

Inspection of the holographic structure may be performed using a microscope, phase contrast microscope, white light interferometer, stylus profilometer (e.g. Dektak®, or the like), atomic force microscope, or indeed any appropriate instrument or optical system for determining the structure of the features of the holographic structure. Although a counterfeiter could in theory take extensive efforts to inspect the holographic structure itself and subsequently to reproduce the same holographic structure in counterfeited versions of a product, the level of effort, complexity and costs involved may be substantial. Even then, authorised users may still be able to determine if there is a pattern of counterfeiting in the marketplace if more than one product with the same “identifier” is tracked.

The identifier may be encoded by the modified design such that the identifier is substantially hidden, masked or otherwise substantially unidentifiable in the projected target image. The identifier may be substantially hidden, masked or otherwise substantially unidentifiable to a human observer, for example to the unassisted vision of a human observer, in the projected target image.

At least one of calculating and modifying the design may comprise using the identifier as part of an algorithm to calculate the modified design.

The method may comprise using an algorithm for calculating a design for the holographic structure that projects the target image. The algorithm may comprise an iterative Fourier-transform algorithm (IFTA), or any other appropriate algorithm for calculating the design. The method may comprise selecting an identifier and using the identifier as part of the algorithm for calculating the design. Using the identifier may result in a modified design that encodes the identifier therein. At least one feature of the algorithm may be selected in dependence on the identifier. For example, at least one of a parameter value, number of iterations, seed or starting point of the algorithm may be selected in dependence on the identifier.

The holographic structure design may consist of a map of phase values (phase hologram) or a map of amplitude values (amplitude hologram) or a map of phase and amplitude values. For brevity, the description below refers mainly to representing the holographic design as a map of phase values; however, such references should be taken as extending to representing the holographic design as a map of phase values or amplitude values or a combination of phase and amplitude values. Where specific phase values are mentioned (e.g. 0, ±π/4, ±π/2, ±3π/4, ±π, or any other phase value), these can be replaced by corresponding amplitude values (e.g. 0, 0.25, 0.5, 0.75, 1, or any other amplitude value).

Calculating the design may comprise calculating a map of phase and/or amplitude values for projecting the target image. Each feature of the design may correspond to one of the phase and/or amplitude values.

The map may comprise a set or array of features. Each feature may be at a different position within the map. Each feature may have an associated phase value, which may be zero or non-zero. The phase value may correspond to a relative phase value (e.g. with reference to a surface or plane of a material comprising the holographic structure, or the like). The phase value or relative phase value may correspond to a depth and/or height or relative depth and/or height of the feature (e.g. with reference to the surface or plane). The phase value or relative phase value may correspond to a refractive index value or difference in refractive index values. The phase value or relative phase value may correspond to an optical length or difference in optical length. Additionally or alternatively, each feature may have an associated amplitude value or amplitude response. For example, the features may be constructed so as to change the amplitude upon reflection and/or transmission from/through the features (e.g. the amplitude value of incident radiation may initially be 1 and then may be changed to 0, 0.25, 0.5, 0.75, 1 or any other amplitude value upon reflection and/or transmission at the feature(s)). Each feature may have an associated amplitude and/or phase response.

The design may comprise a number of features that are distributed in terms of position, size, density, or the like, such that the holographic structure is configured to project the target image. Calculating and/or modifying the design may calculate a phase and/or amplitude value for each of the features and/or the distribution of the features that projects the target image.

The feature(s) may correspond to a pixel of the holographic structure. The feature(s) may reflect and/or transmit e.g. the 0th order reflection/transmission under illumination. The shape of the feature may affect how much of the feature may be illuminated, which may affect the efficiency of reflection/transmission and/or diffraction.

Modifying the design may comprise calculating a map comprising at least one different phase and/or amplitude value such that the target image projected by the holographic structure based on the modified design is indistinguishable from the target image projected before modification of the design.

The method may comprise calculating a phase and/or amplitude value for each feature of the design. The method may comprise modifying at least one of the phase values for each feature of the design. Modifying the design such that at least one feature of the map comprises a different phase value may comprise selecting a different phase value for the feature(s) that is equivalent to the phase value before modification of the design. A map comprising at least one phase value that is equivalent to the phase value before modification of the design may project a same or similar target image to the target image projected before modification of the design. For example, a phase value of 0 may be equivalent to a phase value of 27, or the like. The method may comprise replacing a phase value of at least one feature with a different phase value that is equivalent to the replaced phase value. Inspection of the holographic structure itself may reveal the different phase values, which may not be apparent from the projected target image.

The method may comprise using the identifier to calculate the map of different phase and/or amplitude values.

Calculating a map of different phase and/or amplitude values may provide an identifier that may only be evident or identifiable by inspecting the holographic structure. There may be many different possible maps of phase and/or amplitude values available for the holographic structure which may project the target image. The method may provide a way to encode the identifier into the map of different phase and/or amplitude values in a repeatable, or at least deterministic, manner.

The modified design may be calculated deterministically based on at least one of: the identifier; the algorithm used; and the number of iterations of at least one step in the algorithm. By using an algorithm that deterministically calculates the modified design, an authorised user may be able identify whether or not a holographic structure has an expected pattern of features in the holographic structure, and optionally without necessarily needing to have complete information regarding the pattern of features in the holographic structure. For example, the authorised user may use the identifier to deterministically calculate an expected pattern of features for the holographic structure (e.g. based on a serial number, or the like); inspect at least part of the holographic structure (e.g. of a product comprising the holographic structure); and determine whether or not the inspected pattern of features (e.g. of the product) corresponds to the expected pattern of features (e.g. the calculated design).

Calculating the map of phase and/or amplitude values for projecting the target image may comprise calculating a set or array of features that have associated phase and/or amplitude values for projecting the target image, wherein each feature is at a different position in the map, and each position in the map has one of at least two phase and/or amplitude values.

Calculating the design may comprise assigning one of the phase and/or amplitude values to each of the features at the different positions in the map. The phase and/or amplitude values may be predetermined, for example, the phase and/or amplitude values may be calculated according to an algorithm that calculates an expected phase and/or amplitude value for a given set of parameters for forming the holographic structure in a material.

In an example, one of the phase values may be zero. At least one other of the phase values may be non-zero. One of the phase values may be equivalent to at least one other of the phase values. For example, a phase value of 0 may be equivalent to a phase value of ±2πm for non-zero integer values of m.

Each position in the map may have one of at least three phase values. Alternatively any other suitable number of predetermined values of phase and/or amplitude may be used. For example, each position in the map may have a respective selected one of four, five, six or more predetermined values of phase and/or amplitude.

A respective phase and/or amplitude value for each of the phase and/or amplitude values of the map may be selected from a set of phase and/or amplitude values. The set of phase and/or amplitude values may consist of two different phase and/or amplitude values or may consist of three different phase and/or amplitude values or may consist of more than three phase and/or amplitude values.

The number of phase and/or amplitude values in the design may define a number of levels of the holographic structure. A holographic structure comprising two different phase and/or amplitude values may define a two-level holographic structure. A holographic structure comprising three or more different phase and/or amplitude values may define a three or more level holographic structure, respectively.

At least one of the features may have one of the phase and/or amplitude values and at least one other of the features may have at least one other of the phase and/or amplitude values.

One of the phase values may be 0, which may correspond to an unmodified material surface, a surface level of the material, an average surface level of the material, a plane of the holographic structure, or the like. At least one other of the phase values may define a relative difference in the phase values with respect to the surface level of the material, the average surface level of the material, the plane of the holographic structure, or the like. At least one other of the phase values may be selected from at least one of: ±π/4, ±π/2, ±3π/4, ±π, ±3π/2, ±2π, or indeed any other appropriate phase value, which may define a relative difference in the phase between respective features.

The features may have any appropriate property to impart a relative phase and/or amplitude difference upon radiation reflected and/or transmitted from/through the holographic structure. For example, a relative difference in level, height or the like between the features may cause different spatial components of radiation reflected from the holographic structure to have different phase and/or amplitude values. A relative difference in refractive index and/or optical length and/or scattering and/or absorption between the features may cause different spatial components of radiation transmitted through the holographic structure to have different phase and/or amplitude values. The relative difference in the phase and/or amplitude values of the features may cause an interference pattern to be projected in the far field; the interference pattern may correspond to the target image.

Alternatively or additionally, it may be possible to implement a multi-level phase and/or amplitude holographic structure. The multi-level phase and/or amplitude holographic structure may comprise, for example, three, four or more levels or values of phase and/or amplitude. For example, the features in the holographic structure may have an associated phase and/or amplitude value which may be calculated by an appropriate algorithm. A multi-level phase and/or amplitude holographic structure may be capable of suppressing at least one diffractive order. For example, a two-level phase holographic structure may produce two diffractive orders in the form of a twin image (e.g. two identical projected images), whereas a three-level phase holographic structure may only produce one diffractive order in which one of the orders may be suppressed. It will be appreciated that it may not be possible to completely prevent the formation of a twin image, but there may be a visibly distinguishable difference between the different diffractive orders in the case of the three-level holographic structure. Different phase values may be used to produce the multi-level holographic structure. Additionally or alternatively, different amplitude values may be used to produce the multi-level holographic structure,

The phase of the illumination may be bounded over 0 to 2π. In an example such as a binary or two-level holographic structure, at least one feature of the map may introduce a phase delay of 0 radians and at least one other feature of the map may introduce a relative phase delay of e.g. π radians. In an example such as a three-level holographic structure (which may define a type of multi-level holographic structure), there may be a third level providing e.g. a 2π phase delay, which may have the same interference effect as a 0 radian phase delay in the far field. The three-level and two-level holographic structures may project substantially the same target image under illumination. By inspecting the three-level example under a microscope or by using any appropriate instrument, it may be possible to identify a physical or optical difference between the features introducing e.g. 0, π and 2π phase value differences that are distinguishable from the two-level example having features corresponding to e.g. 0 and π phase value differences. However, the target image projected in the far field in both the two- and three-level examples may be indistinguishable, or at least similar.

The feature(s) having a 2π phase delay may have lower diffraction efficiency than feature(s) having 0 phase delay. For example, the shape of the features may differ such that the area of the different phase delay features may be different. In an example, if the number of features resulting in the lower diffraction efficiency is kept relatively small (for example, compared to the features providing higher diffraction efficiency), the overall diffraction efficiency may not be significantly reduced. It will be appreciated that any diffraction efficiency may be appropriate and that the relative phase delay between the phase values may or may not affect the diffraction efficiency.

The method may comprise using the identifier to select at least one of the phase and/or amplitude values for at least one of the features of the map.

The method may comprise using the identifier to select at least one of the features of the map; and modifying the design by assigning at least one different phase value to the feature(s) that is equivalent to an original phase value of the design.

The different phase and/or amplitude value(s) may not substantially change the target image projected by the holographic structure. However, the different phase and/or amplitude value(s) may be identified by inspecting the holographic structure.

The method may comprise using an algorithm linked to e.g. serial number, unique code, part number, signature, logo, image, photo, name, brand, code, symbol, set of characters, one-time-input, or any form of identification to define which feature(s) may retain the original phase and/or amplitude value as calculated originally and which feature(s) may be assigned at least one different phase and/or amplitude value.

The original phase value may be selected to be 0 and the different phase value may correspond to a relative phase value difference of 2π. The feature(s) having a phase value of 0 and phase value difference of 2π may contribute in a similar manner to the target image formed in the far field under illumination of the holographic structure.

At least one of calculating; and modifying the design may comprise obtaining an initial design of the holographic structure for projecting the target image; and selecting a different phase and/or amplitude value for at least one of the features to modify the design, the modified design projecting a target image that is indistinguishable from, or at least similar to, the target image projectable by the holographic structure corresponding to the initial design.

The initial design may comprise or correspond to an initial guess for the design. The initial design may comprise or correspond to a map of phase and/or amplitude values which may be modified such that the identifier may be encoded within a map of different phase and/or amplitude values. The initial design may be calculated according to any appropriate algorithm, for example an IFTA algorithm, or the like.

The initial design may comprise a map of phase and/or amplitude values comprising at least one of: constant phase and/or amplitude values across at least part of the map; random phase and/or amplitude values across at least part of the map; and a defined pattern of phase and/or amplitude values across at least part of the map.

The initial design may comprise a map having at least one part such as an area of the map. At least one of the parts may comprise features defining constant phase values (e.g. 0, ±π/4, ±π/2, ±3π/4, ±π, or any other phase value). At least one of the parts may comprise features defining random phase and/or amplitude values, for example, a random phase and/or amplitude value assigned to at least one of the features in the part(s). At least one of the parts may comprise features defining a specific pattern of phase and/or amplitude values, for example, a defined phase and/or amplitude value assigned to at least one of the features in the part(s). The defined pattern of phase and/or amplitude values may comprise at least one of: the same phase and/or amplitude value for at least one of the features; and a different phase and/or amplitude value for at least one of the features. The identifier may be used to determine the defined pattern of phase and/or amplitude values.

The initial design may comprise a map of phase and/or amplitude values comprising at least one feature corresponding to the identifier.

The identifier may comprise an initial seed for deterministically generating a map of the features for the design.

The initial seed may be used to provide the initial design, or may be used as part of a calculation for determining the initial design. The initial seed may comprise at least one of: a serial number, identification, code or entry from a one-time-pad correlated with the identification of the material, and the like.

At least one of calculating; and modifying the design may comprise running an algorithm for modifying the design, wherein optionally at least part of the algorithm is run for a defined number of iterations.

The deterministically generated map of features may be repeatable e.g. by using the same initial seed and/or a defined number of iteration(s). A user with knowledge of at least one of: the starting point (e.g. the initial seed), the algorithm for calculating the design, and the number of iteration(s) may be able to determine whether a holographic structure under inspection has the expected (e.g. correct) features. The user may not need to know exact form of the expected holographic structure in advance, but by using the initial seed in conjunction with the algorithm, the user may be able to determine whether at least one of the features of a holographic structure under inspection is expected in order to determine whether or not a product is genuine. At least one of: the initial seed, the algorithm and/or the number of iteration(s) may be secret so that an authorised user checking the authenticity of a product comprising the holographic structure may be able to determine the expected structure without knowing the complete details as to how the design may be calculated and/or modified. The initial seed may define or correspond at least partially to an initial design.

For a selected initial seed, algorithm and/or number of iterations, the holographic structure may project the same target image. However, the map of the features may be different to the map that may have been generated using a different initial seed or set of initial conditions, despite the holographic structure projecting the same or similar the target image under illumination. Inspecting the holographic structure under a microscope or other appropriate instrument may allow a user, manufacturer, dealer, repairer, or any other authorised user to correlate the observed map of features with a map of features calculated under identical initial conditions, and if the correlation is below a required standard, the authorised user may flag the marked item as suspect.

The method may comprise selecting at least one portion of the design and swapping the selected portion(s) with at least one other portion of the design.

The portions selected for swapping may comprise portions that, individually, project or produce substantially the same or similar target image (e.g. a diffractive image, or the like), but that comprise or represent maps that are at least partially different. Said maps that are at least partially different may comprise maps that are generated using different seeds and/or different numbers of iterations (e.g. of an IFTA, or the like).

The design may comprise an array of portions each of which, individually, is configured to project or produce the same or similar target image (e.g. a diffractive image, or the like) as each other portion of the array. At least one portion of the array may comprise or represent a map that is at least partially different to a map that comprised in or represented by at least one other portion of the array. The portions may comprise tile portions that are arranged so as to tile an area of interest.

The method may comprise generating the map comprised in or represented by the selected portion using a first seed and/or first number of iterations and generating the map comprised in or represented by said at least one other portion using a second, different seed and/or a second, different number of iterations.

The method may comprise verifying whether the modified design of the holographic structure is configured to project a target image that is indistinguishable from, or at least similar to, the target image projected by a holographic structure corresponding to the unmodified design.

Verifying the modified design may ensure that information corresponding to the identifier is not scrambled during the swapping process.

The selected portion may comprise at least one of: an area, tile, column, row, or any other suitable shape in the design; and the swapped portion(s) respectively may comprise at least one other of: the area, tile, column, row, or any other suitable shape in the design, respectively, for example portions of the design that individually produce substantially the same or similar diffractive image.

In an example, a tile, column, row, or other suitable portion of the design may be swapped with another tile, column, row, or other suitable portion of the design. The swap may be such as to not cause any change or at least not a substantial change in the target image projected by the modified holographic structure.

The holographic structure may comprise a selected number of computer-generated holograms (CGHs), for instance 16 different CGHs (e.g. tiled in a 4×4 array, or any other appropriate tiled array). Any other suitable number and arrangement of CGHs may be used. Each CGH may be different. This may be achieved by calculating the CGH designs by using different seeds and/or number of iterations. Each of the CGHs may produce the same or similar projected target image. Swapping and/or shuffling of individual CGHs may be such as to not substantially affect the appearance of the projected target image (e.g. a diffractive image, or the like).

Alternatively or additionally, a part (for example, at least one CGH) of the whole holographic structure (which may, for example, comprise an array of tiled CGHs) may be shifted from left to right and/or from top to bottom (or the like) within the hologram design. For example, a column (or row) of CGHs on a left (or top) side of holographic structure may be moved to a right (or bottom) side of the holographic structure. Any other suitable shifting and/or swapping of rows and/or columns and/or other parts of the structure may be provided in other embodiments. The whole holographic structure may be divided into a set of sub-holograms (for example, each sub hologram may comprise an individual CGH) and a subset of the sub-holograms may be shuffled or swapped. By shuffling or swapping a subset of the set of sub-holograms, the projected target image may not be substantially affected by the swapping or shuffling.

The method may comprise modifying the material by at least one of: changing a level of a surface of the material; and modifying a refractive index of the material; and changing the optical scattering properties of the surface of a material; and changing the absorption properties of the surface of a material.

Changing the level of the surface may comprise providing a raised or lowered feature relative to the surface. The method may comprise mapping the features into the material such that the raised and/or lowered features may define different phase values relative to the surface of the material or a plane defined by the holographic structure. Changing the level of the surface and/or modifying a refractive index may comprise at least one of: melting a portion of the surface, ablating the material; moving a portion of the material; depositing material on the surface; otherwise distributing the material; and chemically changing a portion of the material, or the like.

A raised feature may comprise or define a protrusion, bump, projection or any other feature extending at least partially out of the surface. A lowered feature may comprise or define a cavity, crater, or any other feature extending at least partially into the surface. Modifying the refractive index of the material may modify the optical length of the modified part of the material.

A scattering feature may comprise creating a rough surface via localised laser ablation (e.g. by using an ultrashort pulsed laser). An absorbing feature may comprise a chemical modification e.g. oxidation to the surface, caused by localised heating.

The method may comprise modifying the material by using radiation to at least one of: melt, ablate, move, deposit, or otherwise distribute the material; and change a chemical property of the material.

The radiation may be produced by a laser, coherent light source, partially coherent light source, incoherent light source, pulsed laser, continuous wave laser, or any other appropriate source of radiation capable of modifying the material or otherwise interacting with the material. Depending on the choice of material, an appropriate radiation source may be selected. Any appropriate parameter of the radiation may be selected or varied in order to modify the material.

The method may comprise controlling at least one parameter of the radiation to control formation of the features. In an example, a laser may be used to modify the material. The method may comprise controlling any parameter of the laser to controllably modify the material. Parameters of the laser or parameters of the equipment for controlling the laser that may at least partially influence the modification of the material may comprise, but not be limited to, laser peak power, average laser power, wavelength, intensity, laser beam spot size, laser beam quality, wavelength(s), pulse duration, pulse repetition rate, dispersion, laser shutter duration, and the like.

In an example, a material such as glass may be modified using a CO₂ laser. An example procedure for modifying glass using a CO₂ laser is outlined in Wlodarczyk et al., “Direct CO₂ laser-based generation of holographic structures on the surface of glass”, Optics Express, Vol. 24, No. 2, pp. 1447-1462, January 2016, the contents of which is hereby incorporated by reference in its entirety.

In an example, a material such as a metal may be modified using a pulsed UV laser. An example procedure for modifying a metal using a pulsed UV laser is outlined in Wlodarczyk et al., “Laser microsculpting for the generation of robust diffractive security markings on the surface of metals”, Journal of Materials Processing Technology 222, pp. 206-218, March 2015, and Wlodarczyk et al., “Tamper-proof markings for the identification and traceability of high-value metal goods,” Optics Express 25 (13), pp. 15216-15230, 2017, the contents of which is hereby incorporated by reference in its entirety.

The method may be used to modify a product comprising a material such as metal, glass, or the like. The metal may comprise stainless steel (e.g. ST304LD, or the like), nickel, brass, and nickel-chromium Inconel® alloys (e.g. Inconel 625, Inconel 718, Inconel X750, and the like), or the like. It will be appreciated that any appropriate material, metal, glass, or the like may be modified according to the method.

A holographic structure formed on an appropriate material may be at least one of: hard-to-replicate, tamper-proof, resistant to surface abrasion and/or versatile. For example, it has been demonstrated that scratching the holographic structure formed in a metal such as stainless steel may not cause a substantial deterioration in the quality of the replica and/or cause destruction of features that may be inspected to indicate the identifier for the material or product in question.

The method may comprise providing a substance such as a cover gas for use at least during the modifying of the material. The cover gas may interact radiation and/or the material so as to controllably modify the material, for example, to form at least one raised feature (e.g. raised bumps, or the like) and/or at least one lowered feature (e.g. craters, or the like). By providing features with different phase values, which may be bounded over 0 to 2π, different features may correspond to the same or equivalent phase value depending on the relative difference in level of the features. For example, a “bump” of height π may be equivalent to a “crater” of depth π (the difference in level may be equal to 2π). Providing a multi-level (e.g. 3 or more level) holographic structure may suppress at least one of the diffraction orders.

Providing a holographic structure comprising raised features may be more secure than a holographic structure comprising solely lowered features, for example, if the parameter control required for successful modification of the material is more complex for the providing raised features. An appropriate instrument may be used to inspect the raised features. If the holographic structure comprises both raised and lowered features, the instrument may be configured to distinguish between the raised and lowered features.

The identifier may comprise a serial number, unique code, part number, signature, logo, image, photo, name, brand, code, symbol, set of characters, one-time-input, or any form of identification.

The method may comprise forming a plurality of holographic structures in the material, the method comprising tiling the holographic structures in the material.

The plurality of holographic structures may comprise a set of holographic structures. The set of holographic structures may comprise at least one subset of sub-holograms. The method may comprise arranging the at least one subset of sub-holograms in a predetermined pattern within the set of holographic structures.

Depending on the nature of the sub-holograms, then sub-holograms may, for example, generate either the same target images but with two different orientations or two completely different target images with the same or different orientations.

The method may comprise combining the holographic structure with another pattern such as a watermark, QR code design, barcode, or other pattern to generate a patterned holographic structure.

The holographic structures may be tiled with any appropriate relative spacing and/or orientation. The holographic structures may be configured to project the same or different target images. The holographic structures may be configured to encode same or different identifiers. The holographic structures may be tiled to at least partially form a logo, bar, 2D or QR code, or the like, in the material. The design or pattern of tiling may be indicative of an identifier associated with the material.

At least one holographic structure may be tiled or masked such that a background or foreground is in the form of a logo, bar or QR code, or the like. If a bar or QR code is embedded, the code may link to a web address, app, or the like with a form for allowing a picture of the holographic structure (which may be taken by e.g. a smartphone with a macro lens, or the like) to be submitted to a website, server, or the like e.g. for authenticity checking, or the like.

The holographic structure may comprise small patterns embedded that may be too small to impact upon the quality of the projected target image(s), but may be large enough to be inspected under a microscope, or other appropriate instrument. The small patterns may comprise at least one of: a logo, character(s), QR codes, or the like.

In a further aspect, which may be provided independently, there is provided a holographic structure for projecting a target image in the far field under illumination of the holographic structure, the holographic structure comprising:
features based on a modified design that encodes an identifier within the holographic structure for projecting the target image.

The identifier encoded by the modified design may be such that the identifier is substantially hidden, masked or otherwise substantially unidentifiable in the projected target image.

The features may comprise a map of phase and/or amplitude values for projecting the target image, wherein each feature of the design corresponds to one of the phase and/or amplitude values.

The map may comprise a set or array of features that have associated phase and/or amplitude values for projecting the target image, wherein each feature is at a different position in the map, and each position in the map has one of at least two phase and/or amplitude values. Each position in the map may have one of at least three phase and/or amplitude values.

The holographic structure may comprise a plurality of tiled holographic structures. The plurality of tiled holographic structures may comprise a set of holographic structures. The set of holographic structures may comprise at least one subset of sub-holograms. The at least one subset of sub-holograms may be arranged in a predetermined pattern within the set of holographic structures.

The holographic structure may be combined with another pattern such as a watermark, QR code design, barcode or other pattern to generate a patterned holographic structure.

The holographic structure may define a 2, 3, 4 or more level holographic structure. The number of levels in the holographic structure may correspond to the number of phase and/or amplitude values. Each level may correspond to a phase and/or amplitude value.

The design for the holographic structure may be calculated and/or modified according to at least one feature, part or step of any method of the present disclosure. The holographic structure may be formed in a material according to any example of the present disclosure. The holographic structure may be at least partially formed in a material or product using any laser system of the present disclosure, or indeed using any appropriate instrument for modifying or printing the holographic structure in the material or product.

According to a further aspect, which may be provided independently, there is provided a product comprising a holographic structure as claimed or described herein.

According to another aspect, which may be provided independently, there is provided a computer program product that when executed by a processing system or control unit causes the processing system or control unit to at least partially implement a method as claimed or described herein.

At least partially implementing the method may comprise at least one of:
calculating a design for the holographic structure for projecting the target image; and
modifying the design to encode an identifier within the holographic structure for projecting the target image.

The method may comprise controlling a laser system for modifying a material by mapping features corresponding to the modified design into the material.

The processing system or control unit may comprise a processor and a memory. The processing system or control unit may comprise a communications module, such as a wireless and/or wired communications module. The memory may be configured to store at least part of the computer program product. The control unit may be coupled or in communication with at least one input device or user input device and/or at least one output or user output device. Examples of suitable user input devices include a device such as a keyboard, mouse, trackball, switch, touch screen or contact pad such as a capacitive or inductive touch screen or contact pad, optical and/or camera based input system and/or the like. Examples of suitable output or user output devices include a display, screen, led, speaker or other audio output, haptic output device, a virtual reality headset, a data store, a network, a remote server, and/or the like.

The computer program product may be provided on a carrier medium. The carrier medium may be a tangible, non-transient carrier medium, such as a flash drive, memory stick, optical disk or carrier, magnetic disk or carrier, memory, ROM, RAM, and/or the like. The carrier medium may be, comprise or be comprised in a non-tangible carrier medium such as an electromagnetic wave, electronic or magnetic signal, digital data and/or the like.

In addition, it will be well understood by persons of ordinary skill in the art that whilst some embodiments may implement certain functionality by means of a computer program having computer-readable instructions that are executable to perform the method of the embodiments, the computer program functionality could be implemented in hardware (for example by means of a CPU or by one or more ASICs (application specific integrated circuits), FPGAs (field programmable gate arrays) or GPUs (graphic processing units)) or by a mix of hardware and software.

According to a further aspect, which may be provided independently, there is provided a system for forming a holographic structure in a material, comprising a control system for carrying out the method of any one of claims 1 to 23 to modify a design for the holographic structure; and a laser system for modifying the material according to the design.

The control system may comprise the computer program product of any other example of the present disclosure.

According to a further aspect, which may be provided independently, there is provided a method for determining an authenticity of a material comprising a holographic structure formed by a method as claimed or described herein, the method comprising:
inspecting at least part of the holographic structure to determine a design of the holographic structure; and
comparing the inspected design with an expected design.

The expected design may be provided by a user, calculated according to an algorithm, or the like.

The method may comprise calculating a design for the holographic structure for projecting the target image; and modifying the design to encode an identifier associated with the material within the holographic structure for projecting the target image, wherein the modified design at least partially comprises the expected design.

According to a further aspect, which may be provided independently, there is provided a computer program product that when executed by a processing system or control unit causes the processing system or control unit to at least partially implement a method as claimed or described herein.

The computer program product may be configured to compare an inspected design of a holographic structure with an expected design for the holographic structure.

According to a further aspect, which may be provided independently, there is provided a system for determining an authenticity of a material comprising a holographic structure formed by a method as claimed or described herein, comprising:
an inspection system for inspecting a design of the holographic structure; and
a comparison system for comparing the inspected design with an expected design.

The inspection system may comprise a microscope, phase contrast microscope, white light interferometer, stylus profilometer (e.g. Dektak®, or the like), atomic force microscope, or indeed any appropriate instrument or optical system for determining the structure of the features of the holographic structure. The inspection system may comprise a computer program product of any appropriate example of the present disclosure, or at least may be configured to at least partially implement any appropriate method of the present disclosure for inspecting a design of the holographic structure. The comparison system may comprise a computer program product of any appropriate example of the present disclosure, or may be configured to at least partially implement any appropriate method of the present disclosure for comparing the inspected design with the expected design. The expected design may be calculated in accordance with any example of the present disclosure.

At least one feature of any example, aspect or embodiment of the present disclosure may replace any corresponding feature of any example, aspect or embodiment of the present disclosure. At least one feature of any example, aspect or embodiment of the present disclosure may be combined with any other example, aspect or embodiment of the present disclosure.

### BRIEF DESCRIPTION OF THE DRAWINGS

These and other examples of the present disclosure will now be described by way of example only, and with reference to the accompanying drawings, in which:

FIG. 1 is a schematic view of an arrangement for indicating the authenticity of a material;

FIG. 2 is a schematic view of a system for modifying a material by mapping features corresponding to a target image into the material according to an example of the present disclosure;

FIG. 3 is a schematic view of a laser system for modifying the material according to an example of the present disclosure;

FIGS. 4a to 4d are perspective view images of craters formed in a material at various laser pulse energy levels;

FIGS. 5a to 5c respectively illustrate an elevated view image of a map of craters formed in a material; a perspective view image of a map of craters formed in a material; and a graph indicating the level of the craters as a function of position in a material;

FIG. 6 is a perspective view image of features formed on the surface of a material that can be used as the basis of an amplitude hologram;

FIG. 7 is a schematic side view of a crater formed in a material as part of a holographic structure contributing to a relative phase delay in radiation reflected from the surface and the crater;

FIG. 8 is a schematic illustration of a method for marking a material and determining the authenticity of the material;

FIGS. 9 and 10 respectively show schematic illustrations of methods of forming a holographic structure in a material according to examples of the present disclosure;

FIG. 11 is a schematic illustration of a plurality of computer generated holograms (CGHs) and corresponding diffractive images projected by some of the CGHs;

FIG. 12 is a schematic illustration of a method of forming a holographic structure in a material according to an example of the present disclosure;

FIGS. 13a to 13c respectively illustrate different examples of CGHs and corresponding diffractive images projected by the CGHs;

FIGS. 14 and 15 respectively show schematic illustrations of methods of forming a holographic structure in a material according to examples of the present disclosure;

FIGS. 16a and 16b are images of a projected replica of a target image in the far field for two-level and three-level holographic structures, respectively;

FIG. 17 depicts a hologram design including a plurality of tiled CGHs organised into a pattern;

FIG. 18 depicts a design for a patterned holographic structure produced by combining a CGH with a QR code design;

FIG. 19 is a schematic illustration of an example of a system for forming a holographic structure according to an example of the present disclosure; and

FIG. 20 is a schematic illustration of an example of a system for determining an authenticity of a material including a holographic structure according to an example of the present disclosure.

### DETAILED DESCRIPTION OF THE DRAWINGS

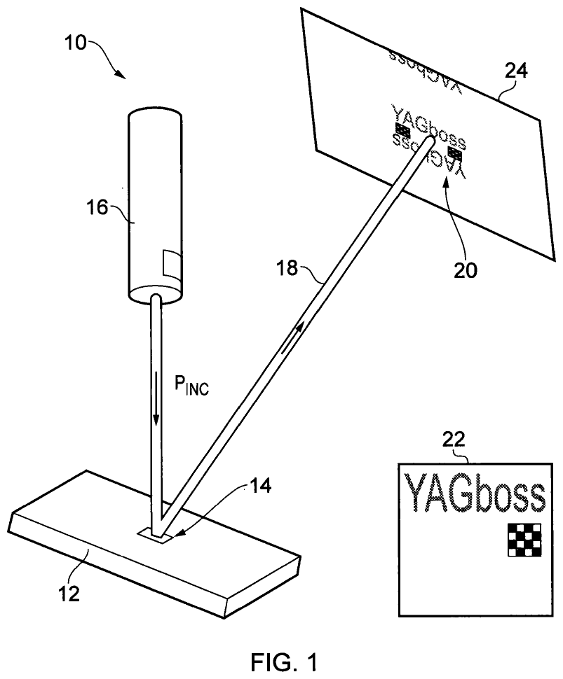

FIG. 1 illustrates an arrangement 10 for providing a basic check of the authenticity of a product, which in this example is illustrated as being in the form of a material 12. The material 12 has been modified to include a holographic structure 14. A laser 16 is used to illuminate at least part of the holographic structure 14 such that reflected radiation 18 projects a replica 20 of a target image 22 in the far field (e.g. for imaging on a screen 24). Providing the replica 20 imaged on the screen 24 is as expected, a user may assume that the material 12 is genuine. As explained herein, it is possible to hide information in the holographic structure 14 that is indicative of the authenticity of the material 12 without the information being revealed in the replica 20. Only an authorised user such as a manufacturer may be able to determine whether the material 12 is authentic by inspecting the holographic structure 14 directly and checking whether the holographic structure 14 is as expected.

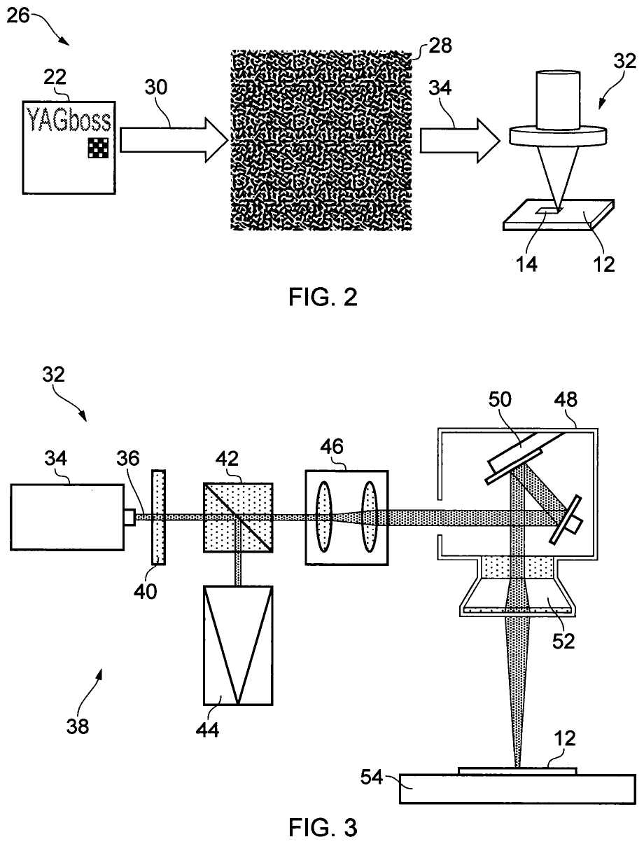

FIG. 2 illustrates part of a method 26 for forming a holographic structure 14 in the material 12. Initially, a target image 22 is selected and used to calculate a design 28 of the holographic structure 14. In this example, the calculation of the design 28 is performed according to an iterative Fourier-transform algorithm (IFTA) and tiling of the calculated phase distributions 30. This calculation is described in Wyrowski et al., “Iterative Fourier-transform algorithm applied to computer holography”, J. Optical Society of America A, Vol. 5, pp. 1058-1065, 1988, and Wyrowski, “Iterative quantization of digital amplitude holograms”, Applied Optics, Vol. 28, pp. 3864-3870, 1989, the contents of which is hereby incorporated by reference in its entirety. A laser system 32, only part of which is shown in FIG. 2, is used to modify the material 12 by mapping features 34 corresponding to a phase and/or amplitude value (e.g. each feature may correspond to a pixel of a certain phase and/or amplitude value) in the design 28 into the material 12. The mapped features define a map of phase values in the material 12 that forms the holographic structure 14.

FIG. 3 illustrates the laser system 32 used to modify the material 12. The laser system 32 includes a laser 34 outputting a laser beam 36. The average power in the laser beam 36 is controllable using a power control arrangement 38 that includes a λ/2 waveplate 40, polarising beam splitter 42 and beam dump 44. The laser beam 36 from the power control arrangement 38 is expanded using a beam expander 46 and subsequently directed into a beam scanning apparatus 48. The beam scanning apparatus 48 includes a pair of galvo-scanning mirrors 50 for changing the direction of the laser beam 36. A lens 52 (e.g. an F-theta lens or the like) focuses the changing-direction laser beam 36 onto the material 12, which itself is mounted on a work piece 54 (e.g. translation stage). The focused laser beam 36 has a higher intensity at the material 12 and can be used to modify the material. By changing the direction of the laser beam 36, it is possible to map features corresponding to a phase value into the material 12. The modification process depends on at least the material used and the optical parameters of the laser system 32. It will be appreciated that any appropriate laser-based process may be used to modify the material as required, and that the optical parameters selected may depend on the type of material used and/or requirements for the holographic structure 14.

In the present example, the laser system 32 is used to apply marks to the surface of a metal so as to form a holographic structure. In this example, the laser 34 is configured to produce 35 ns full-width half maximum (FWHM) laser pulses at a wavelength 355 nm. The lens 52 focuses the laser beam 36 to a FWHM beam diameter of 11±2 μm (as measured at 1/e² of its maximum intensity) at the material 12. The laser pulses are delivered on demand to a certain location on the material 12 e.g. in the form of a point-and-shoot operation. The time taken to generate a 1 mm×1 mm holographic structure including over 15,000 features is 7 seconds.

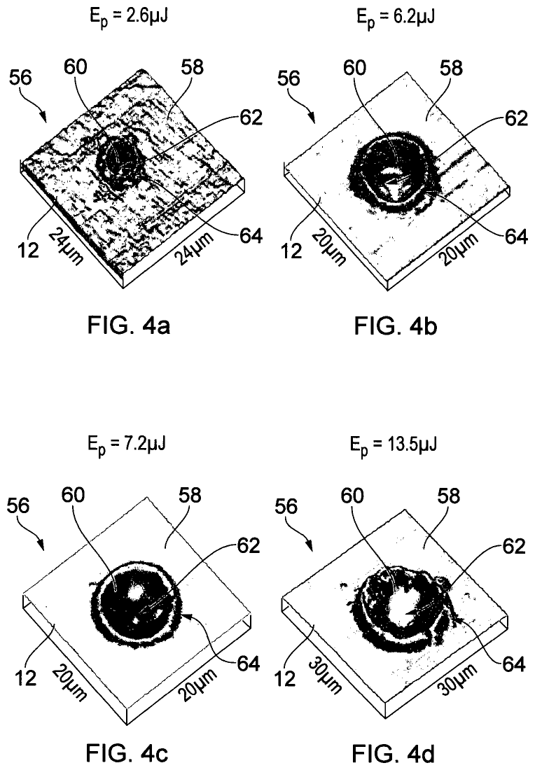

FIGS. 4a-4d each illustrate in more detail a feature 56 in a surface 58 of the material 12 that has been modified using the laser system 32. The features 56 in this example takes the form of an approximately circular crater 60, the dimensions of which depend on the pulse energy of the laser beam 36. FIGS. 4a-4d illustrate the crater 60 formed in stainless steel (ST304LD in this example) according to a pulse energy of 2.6 μJ, 6.2 μJ, 7.2 μJ and 13.5 μJ, respectively. For reference, the dimensions of the sides of the portion of material 12 illustrated by FIGS. 4a-4d is 24 μm, 20 μm, 20 μm, and 30 μm, respectively. Craters can also be formed on the surface of other metals such as nickel, brass, nickel-chromium Inconel® alloys (e.g. Inconel 625, Inconel 718, and Inconel X750, and the like), and the like. Features such as craters can be formed in other materials such as glass. In the example of glass, a CO₂ laser system can be used to form features in the glass. It will however be appreciated that there are many different laser system and material 12 selections that can be made by selecting appropriate parameters.

In each of the figures, the crater 60 extends into the surface 58 such that a centre 62 of the crater 60 is at a lower level than the surface 58. An edge 64 of the crater 60 defines a ridge that is at a higher level than the surface 58. The process of formation of the crater depends on a number of parameters but in this example it is thought that the craters 60 are formed by localised melting or a combination of melting and evaporation. It will be appreciated that other types of light-matter interactions (e.g. which may cause melting, ablation, moving, depositing, or any other form of material distribution, redistribution, modification, or the like) may result, or at least be dominant, in the formation of craters 60 and/or other types of features. It will be appreciated that the formation of the craters 60 or other types of features depends on the type of laser system used, the material type, local conditions, type of cover gas, as well as any other relevant parameters.

Depending on the desired type of feature, it may be possible to selectively form either a raised feature or a lowered feature in the material during formation of the feature, for example as described in WO2012038707. As explained previously, the type of feature produced depends on a number of parameters. Examples of a raised feature includes: a protrusion, bump, projection or any other feature extending at least partially out of the surface (e.g. of the material, or the like). Examples of a lowered feature includes: a cavity, crater, or any other feature extending at least partially into the surface (e.g. of the material, or the like). Modifying the refractive index of the material may modify the optical length of the modified part of the material.

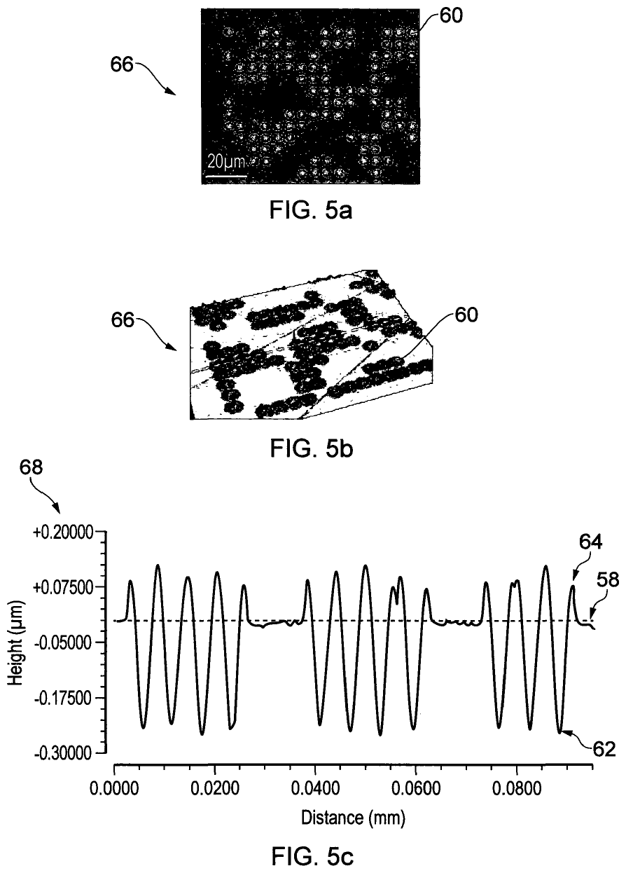

FIGS. 5a-5b respectively illustrate an elevated view image of a map 66 of craters 60 formed in a material 12; and a perspective view image of another map 66 of craters 60 formed in a material 12. FIG. 5c illustrates a graph 68 indicating the level (e.g. the height in μm) of the craters 60 as a function of position (e.g. distance in mm) in a material 12. Each crater 60 has an approximate depth (or relative difference in level) of 250 nm and may be considered to be optically smooth. The example of FIG. 5c represents a two-level (or binary) phase hologram in the surface of stainless steel. The difference in the height between the surface 58 and the centre 62 of the crater 60 contributes to a relative phase delay between radiation reflected from the surface 58 and from the centre 62.

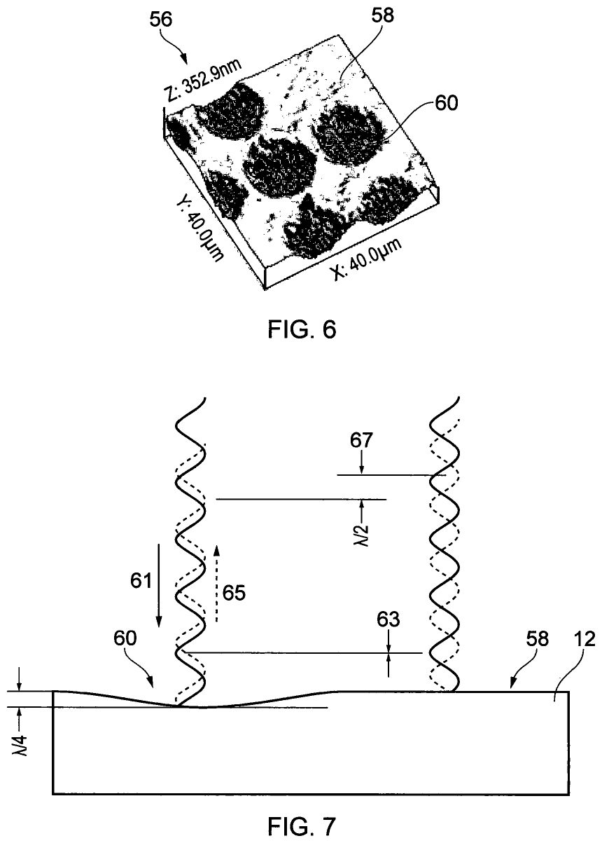

FIG. 6 is a perspective view atomic force microscopy (AFM) image of features 56 formed on the surface 58 of a material that can be used as the basis of an amplitude hologram. In this example, the features 56 are in the form of craters 60. However, the internal surface of the craters 60 is shaped (e.g. by having a non-uniform or rough surface) to cause scattering of incident radiation, hence reducing the amplitude of directly reflected light. The features may be more highly scattering or absorbing than the surface 58 surrounding the craters 60. In this example, the material is 304-grade stainless steel and each feature 56 has been generated by 80 laser pulses, each with a duration of 6 ps at a wavelength of 343 nm, using a 70 mW average power and a 400 kHz pulse repetition frequency.

FIG. 7 illustrates a crater 60 in a material 12 that is illuminated with radiation, as indicated by arrow 61, for projecting a replica of the target image, as described in relation to FIG. 1. The radiation 61 for illuminating the surface 58 and the crater 60 of the material 12 is in phase as indicated by arrows 63. In this example, the crater 60 has a depth that is equivalent to a quarter wavelength λ/4 (i.e. π/2 radians) such that radiation reflected, as indicated by arrow 65, from the crater 60 is relatively out of phase 65 by λ/2 (i.e. π radians), as indicated by arrows 67, with light reflected from the surface 58. The presence of the crater 60 causes the formation of the replica (see FIG. 1) in the far field. The relationship between the relative phase delay (Δφ) between radiation reflected from the crater 60 and the surface 58 and the depth (d) of the crater 60 is defined by Δφ=4πd/λ. Since the phase change is bounded by 0 and 2π, any change in the depth leading to a phase change Δφ greater than 2π or less than 0 has the same effect as Δφ modulo 2π. Therefore, a phase delay of 2π is equivalent to a phase delay of 0, 4π, and the like.

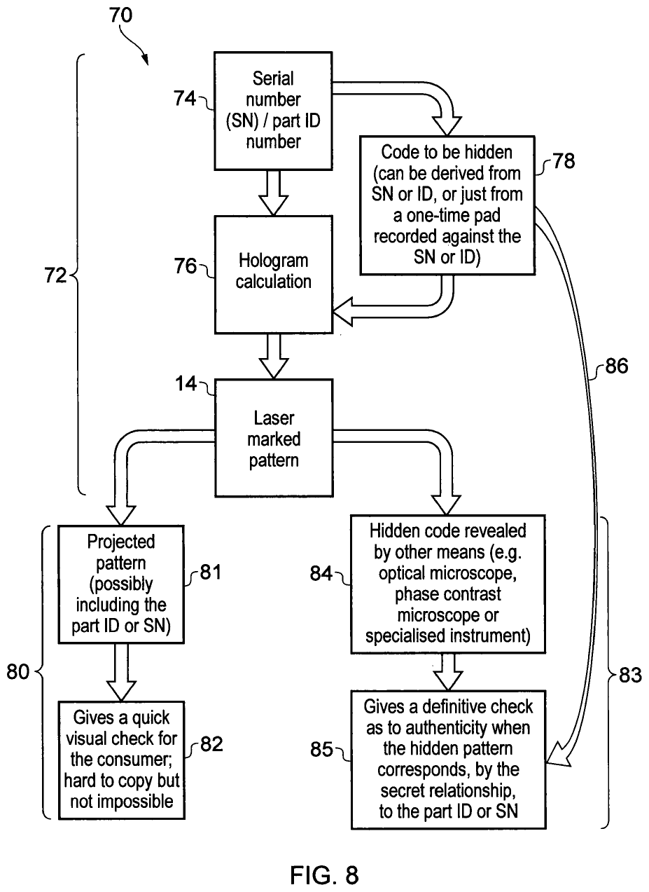

With reference to FIGS. 1 to 7, FIG. 8 is a schematic illustration of a method 70 for modifying a material 12 and determining the authenticity of the material 12 after the material 12 has been marked. In a first part 72 of the method 70, the material 12 is marked with a holographic structure 14. Initially, an identifier 74, which in this example is in the form of a serial number, part ID or number, is used to calculate or modify a design as part of a hologram calculation 76 for the holographic structure 14. The method includes calculating a design for the holographic structure for projecting a target image 22 as part of the hologram calculation 76. The method further includes modifying the design to encode the identifier 74 within the holographic structure 14 for projecting the target image 22, which may also be performed as part of the hologram calculation 76.

The identifier 74 is hidden or otherwise encoded within the modified design. For example, the identifier 74 can be in the form of a hidden code 78 (such as may be derived from the serial number, part ID or number, or from a one-time pad recorded against the serial number of part ID, or the like) within the modified design in such a manner that the holographic structure 14 projects a replica 20 of the target image 22 that is indistinguishable from, or at least similar to, a replica of the target image where the design does not contain a hidden code 76. Features corresponding to phase values calculated in the modified design are mapped into the material 12 by using the laser system 32 to form a laser marked pattern or holographic structure 14 in the material 12.

In a second, optional, part 80 of the method 70, a user can perform a quick visual check of the authenticity of the holographic structure 14 in accordance with the procedure outlined in relation to FIG. 1. In the second part 80, a replica 20 of the target image 22 (e.g. in the form of a projected pattern 81) is projected in the far field. The projected pattern 81 may include a serial number, part ID or the like, which is not hidden so that the user (such as a consumer) can perform a quick visual check 82 of the authenticity of the material 12. It will be appreciated that the quick visual check 82 may be hard to copy, but not impossible. However, the consumer or other user may be able to quickly perform a basic check on the authenticity of the material 12.

In a third part 83, an authorised user inspects the holographic structure 14 to determine the authenticity of the material 12. In an inspection step 84, the hidden code 78 is determined by using a microscope, phase contrast microscope, or specialised instrument, or the like so as to provide a definitive check 85 of the authenticity of the hidden code 78 when the hidden code (e.g. which may be in the form of a hidden pattern) corresponds, by the secret relationship, to the identifier 74. The method 70 includes a step 86 of comparing the inspected holographic structure 14 with the expected features for the holographic structure 14.

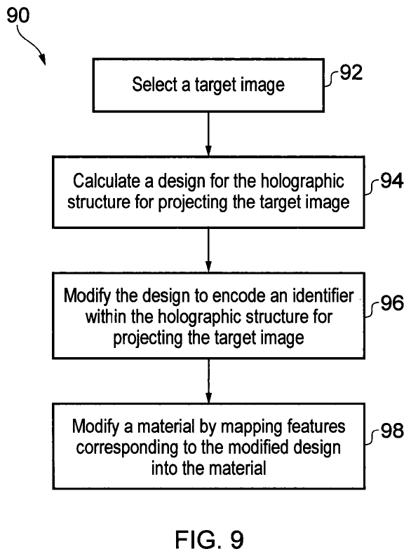

FIGS. 9, 10, 12, 14 and 15 respectively show schematic illustrations of methods of forming a holographic structure in a material while making reference to features described in relation to FIGS. 1 to 8.

FIG. 9 illustrates an example method 90 for forming a holographic structure 14 in a material 12. The method 90 includes a step 92 of selecting a target image 22 such that the holographic structure 14 is configured to project the selected target image 22 in the far field under illumination of the holographic structure 14. The method 90 further includes a step 94 of calculating a design 28 for the holographic structure 14 for projecting the target image 22. The method further includes a step 96 of modifying the design 28 to encode an identifier (e.g. a serial number, unique code, part number, signature, logo, image, photo, name, brand, code, symbol, set of characters, one-time-input, or any form of identification, or the like) within the holographic structure 14. The method 90 further includes a step 98 of modifying the material 12 by mapping features corresponding to the modified design 28 into the material 12.

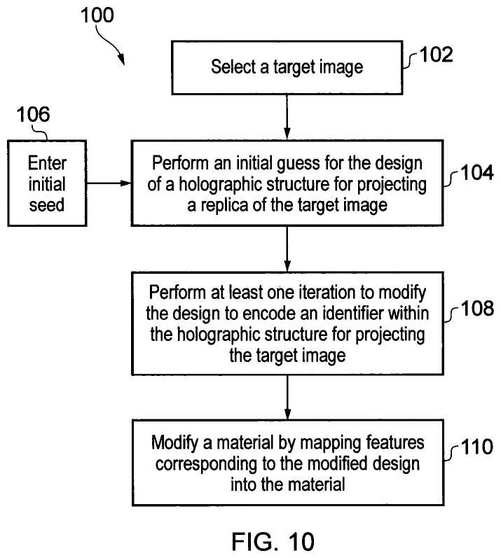

FIG. 10 illustrates an example method 100 for forming a holographic structure 14 in a material 12. The method 100 includes a step 102 of selecting a target image 22 such that the holographic structure 14 is configured to project the selected target image 22 in the far field under illumination of the holographic structure 14. The method 100 further includes a step 104 of performing an initial guess for the design 28 of the holographic structure 14 for projecting a replica of the target image 22. Optionally, the method 100 includes a step 106 of entering an initial seed for deterministically generating a map of the features for the design 28. An example of the initial seed includes a serial number, or the like, that is used to define initial conditions to deterministically generate the map, e.g. as part of the step 104. The method 100 further includes a step 108 of performing at least one iteration of an algorithm to modify the design 28 to encode an identifier within the holographic structure 14 for projecting the target image 22. The method 100 further includes a step 110 of modifying the material 12 by mapping features corresponding to the modified design 28 into the material 12.

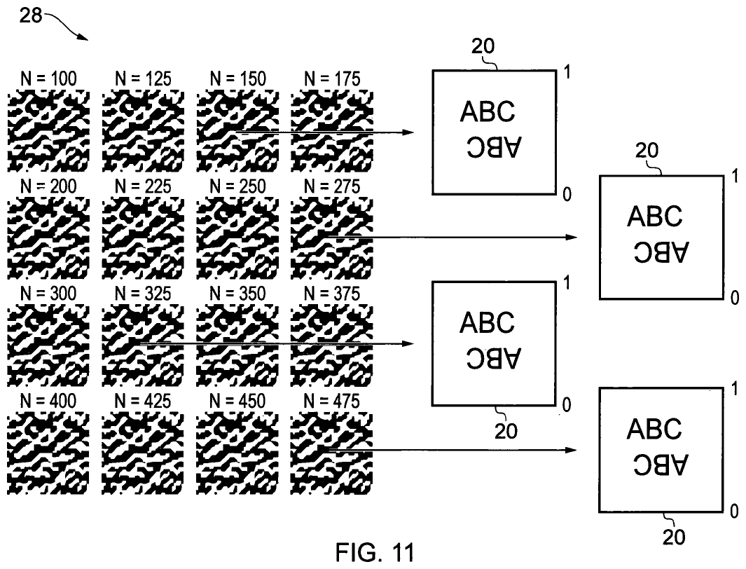

FIG. 11 depicts a hologram design 28 constructed from sixteen different computer generated holograms (CGHs) each of which may be calculated, for example, using the method 100 of FIG. 10. For clarity, the CGHs in FIG. 11 are depicted as individual tiles spaced apart from each other. However, in reality the individual tiles may be joined together in a 4×4 array to form one single hologram design 28 comprising the sixteen CGHs. Each of the different CGHs projects or produces the same or very similar replica 20 (e.g. each CGH projects or produces similar diffractive images). Shuffling and/or swapping of the CGHs may not affect the appearance of the replica 20 since the replicated images are indistinguishable from each other (or at least it may be very difficult for a user to visually identify differences between the replicas 20 produced by each CGH). In the present example, each CGH is designed using a different number of iterations N in the IFTA. As depicted by FIG. 11, the number of iterations N used to produce each CGH is between 100 and 475 iterations (separated by 25 iterations between each subsequent CGH). The initial seed was the same for designing all sixteen CGHs (e.g. the initial phase values contained zeros). FIG. 11 also depicts four replicas 20 produced by the CGHs that represent N=150, 275, 325 & 475 iterations respectively. The CGHs are sufficiently similar to project or produce similar replicas 20. However, there are subtle differences between the sixteen CGHs that, when mapped onto the holographic structure 14 of the material 12, can be inspected to determine whether or not the pattern of CGHs in the hologram design 28 indicates that an associated product is genuine.

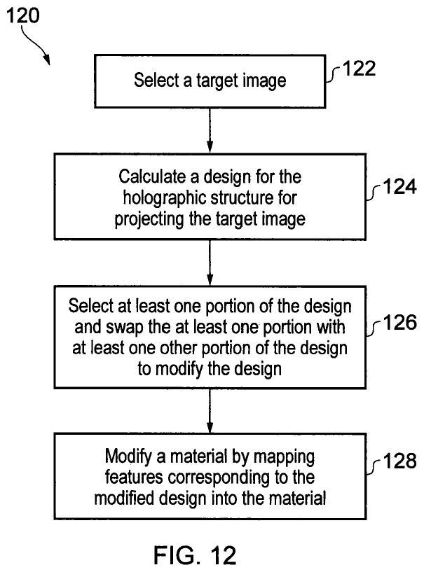

FIG. 12 illustrates an example method 120 for forming a holographic structure 14 in a material 12. The method 120 includes a step 122 of selecting a target image 22 such that the holographic structure 14 is configured to project the selected target image 22 in the far field under illumination of the holographic structure 14. The method 120 further includes a step 124 of calculating a design 28 for the holographic structure 14 for projecting the target image 22. The method 120 further includes a step 126 of selecting at least one portion of the design 28 and swapping the at least one portion with at least one other portion of the design 28 to modify the design 28. The method 120 further includes a step 128 of modifying the material 12 by mapping features corresponding to the modified design 28 into the material 12.

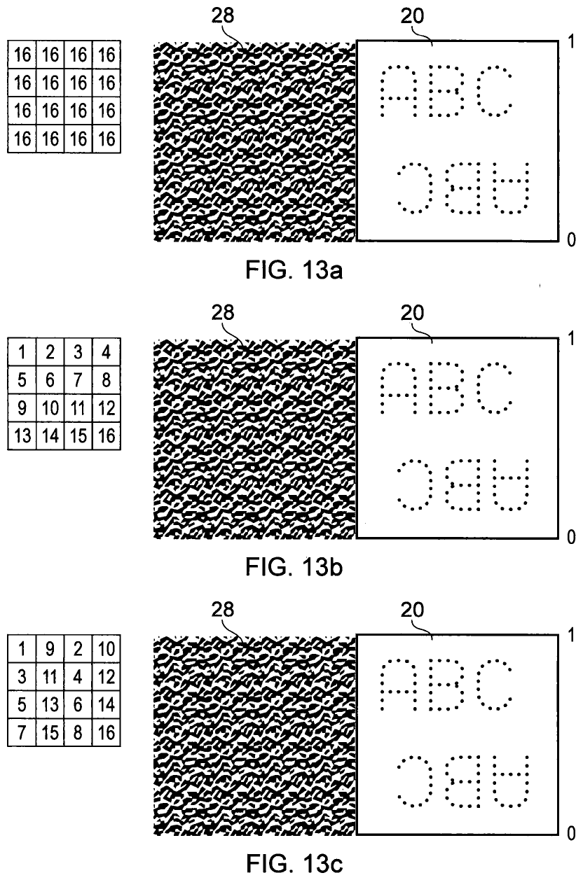

FIGS. 13a to 13c depict different examples of hologram designs 28 (centre image) constructed using sixteen CGHs arranged in a pattern (left image) to form an identical or nearly identical replica 20 (right image). FIG. 13a depicts a hologram design 28 constructed using sixteen identical CGHs (each CGH is referenced as number “16”), for example, using the method 100 of FIG. 10. The reference number of each CGH may, for example, refer to the number of iterations used to produce the CGH. FIG. 13b depicts an alternative hologram design 28 constructed using sixteen different CGHs (the CGHs each have a different reference number from “1” to “16”), for example, using the method 100 of FIG. 10 with reference to the example of FIG. 11. FIG. 13c depicts an alternative hologram design 28 constructed using the same CGHs as in FIG. 13b. However, the CGHs have been shuffled as depicted in the pattern of the left image, for example, using the method 120 of FIG. 12. The replicas 20 projected using the designs 28 of FIGS. 13a, 13b & 13c are indistinguishable (or at least difficult for a user to visually identify differences between them).

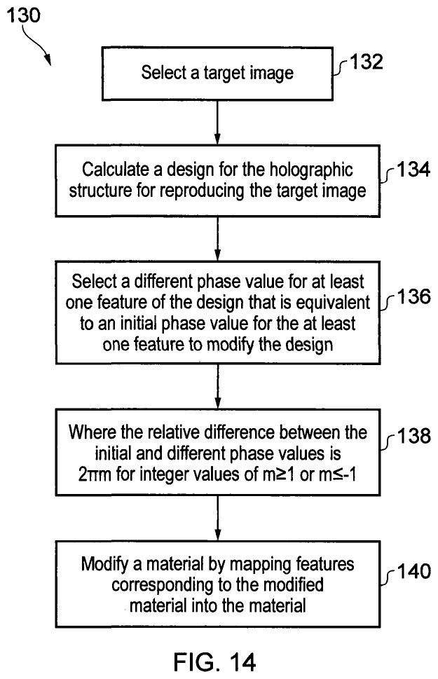

FIG. 14 illustrates an example method 130 for forming a holographic structure 14 in a material 12. The method 130 includes a step 132 of selecting a target image 22 such that the holographic structure 14 is configured to project the selected target image 22 in the far field under illumination of the holographic structure 14. The method 130 further includes a step 134 of calculating a design 28 for the holographic structure 14 for projecting the target image 22. The method 130 further includes a step 136 of selecting a different phase value for at least one feature of the design that is equivalent to an initial phase value for the at least one feature to modify the design 28. The method 130 further includes a step 138 where the calculation and/or modification of the design 28 results in a design 28 where the relative difference between the initial and different phase values is 2πm (2*pi*m) for integer values of m≥1 (“m” greater than or equal to plus one) or m≤−1 (“m” less than or equal to minus one). The method 130 further includes a step 140 of modifying the material 12 by mapping features corresponding to the modified design 28 into the material 12.

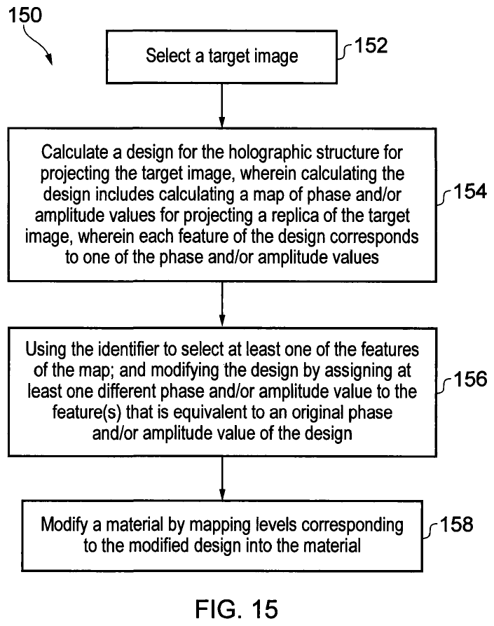

FIG. 15 illustrates an example method 150 for forming a multi-level holographic structure 14 in a material 12. The method 150 includes a step 152 of selecting a target image 22 such that the holographic structure 14 is configured to project the selected target image 22 in the far field under illumination of the holographic structure 14. The method 150 further includes a step 154 of calculating a design 28 for the holographic structure 14 for projecting the target image 22. In step 154, calculating the design 28 includes calculating a map of phase and/or amplitude values for projecting a replica 20 of the target image 22, wherein each feature of the design 28 corresponds to one of the phase and/or amplitude values. The method 150 further includes a step 156 of using an identifier to select at least one of the features of the map and modifying the design by assigning at least one different phase value to the feature(s) that is equivalent to an original phase value of the feature(s) of the design 28. The method 150 further includes a step 158 of modifying the material 12 by mapping features corresponding to the modified design 28 into the material 12. The features may be in the form of levels or phase values or provide a phase response. Additionally or alternatively, the features may be in the form of amplitude values or provide an amplitude response. For example, at least one or all of the features may be used to impart a phase delay onto incident radiation (e.g. at the feature(s)) reflected and/or transmitted by the holographic structure 14. Additionally or alternatively, at least one or all of the features may be used to provide impart an amplitude response (e.g. at the feature(s)) onto incident radiation reflected and/or transmitted by the holographic structure 14. The holographic structure 14 may comprise features providing a phase-only response (which may be referred to as a phase hologram), amplitude-only response (which may be referred to as an amplitude hologram), or a phase-and-amplitude response (which may be referred to as a phase-amplitude hologram).

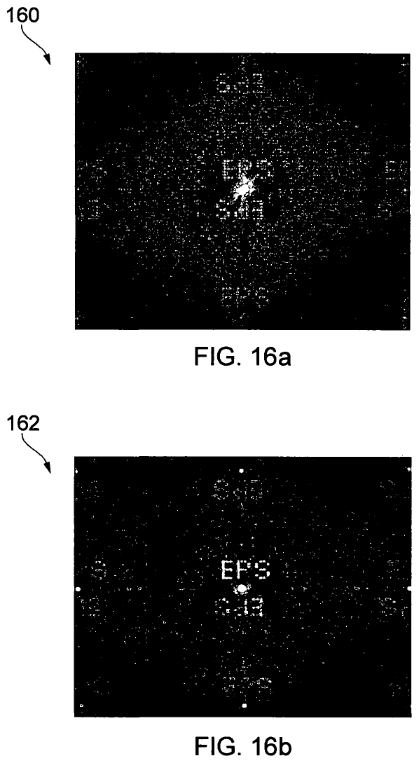

In an example, the method 150 modifies the design 28 such that the map includes features that define a phase value or level in the holographic structure 14. With reference to the example illustrated by FIG. 16a, there is shown a replica 160 projected by a holographic structure 14 that includes a two-level holographic structure. The two-level holographic structure 14 results in the projection of a “twin image”, or “−1^{st} diffraction order image” in the far field such that a mirror-like image is projected. With reference also to the example illustrated by FIG. 16b, there is shown a replica 162 projected by a holographic structure 14 that includes a three-level hologram. The three-level holographic structure 14 breaks the symmetry of the holographic structure, thereby suppressing the formation of a “twin image”, which can be observed by comparing FIGS. 16a & 16b. Alternatively or additionally, it may be possible to define more than one amplitude value or level in the holographic structure 14. In such a holographic structure 14 comprising more than one amplitude value (e.g. in the form of a three-level amplitude hologram or the like), it may be possible to suppress the formation of a “twin image”.

The two-level replica 160 includes two possible nominal phase and/or amplitude values for the features of holographic structure 14. By way of example, these two phase values could be 0 radians (e.g. corresponding to a surface level of the material) and π radians (e.g. corresponding to a crater 60, or any other appropriate feature), or indeed any other appropriate phase values.

The three-level replica 162 includes three possible nominal phase and/or amplitude values for the features of holographic structure 14. By way of example, these three phase values could be 0 radians (e.g. corresponding to a surface level of the material), 2π/3 radians (e.g. corresponding to a crater 60, or any other appropriate feature extending into the surface of the material), and −2π/3 radians (e.g. corresponding to a bump (not shown), or any other appropriate feature extending out of the surface of the material, or the like). In another example, the three possible phase values are: 0 radians, 2π/3 radians (e.g. corresponding to a crater 60 of a certain depth and width), and 4π/3 radians (e.g. a crater 60 corresponding to a relatively deeper and/or wider crater). As noted previously, the replica 162 of the three-level holographic structure 14 includes a suppressed “twin image” in the far field. Fine process control may be required in order to form a three-level (or higher) holographic structure 14, which may be harder to copy. By providing the quick visual check described in relation to FIG. 1, a user may be able to identify an authentic material 12 by visually inspecting the replica 162 projected in the far field for any suppression of “twin images”, which may indicate that the material 12 is genuine.

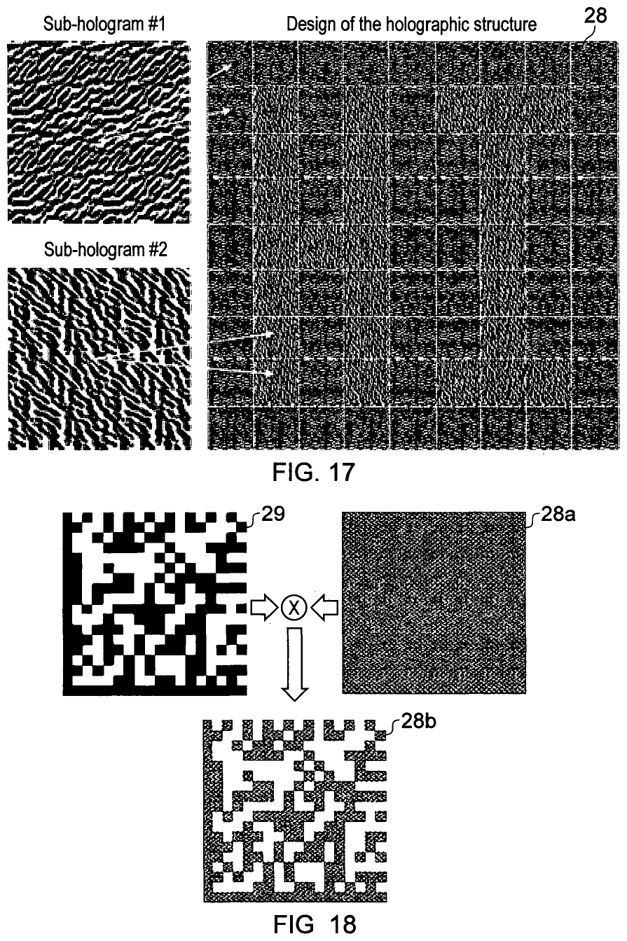

FIG. 17 depicts a hologram design 28 comprising a plurality of tiled CGHs (e.g. a set of tiled CGHs). In this example, there are two subsets of CGHs arranged to form a pattern (in this example the pattern is in the form of “HI” lettering). Any suitable pattern may be used in alternative embodiments, for example a watermark or the like. A first sub-hologram (or CGH) is denoted “#1” and forms a background of the design 28. A second sub-hologram (or CGH) is denoted “#2” and forms the lettering. Any appropriate pattern can be provided. The sub-holograms #1 and #2 can produce substantially the same image but may have a different characteristic (e.g. using the same initial seed but each generated using a different number of iterations with the IFTA algorithm, or the like). Additionally or alternatively, the sub-holograms #1 and #2 may be configured to produce the same or similar hologram but with a different orientation (e.g. the projected images may be perpendicular to each other, or the like). Providing a set of CGHs or sub-holograms with different designs and/or patterning may be difficult to replicate consistently.

FIG. 18 illustrates a hologram design 28a that is combined with another pattern (in this example, a QR code design 29 but it could be a watermark, barcode or other pattern) to generate a design 28b for generating a patterned holographic structure. The combination in this example is performed by multiplying amplitude values (i.e. 1 or 0) at different positions within the QR code design 29 with corresponding positions of the hologram design 28a. The patterned holographic structure can provide the functionality of a QR code, as well as being used to check the authenticity of the product as described herein. Providing a patterned holographic structure may be difficult to replicate consistently.

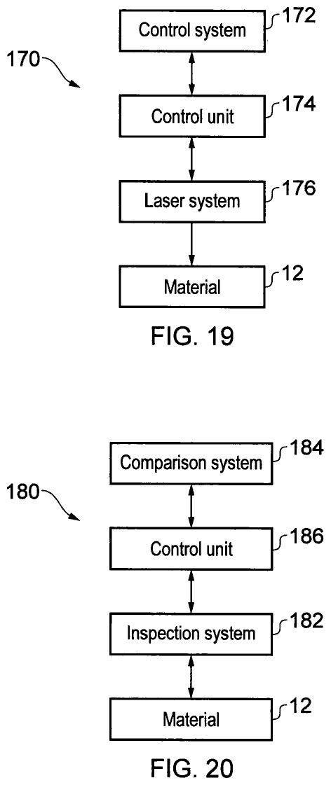

FIG. 19 illustrates a system 170 for forming the holographic structure 14 in the material 12. The system 170 includes a control system 172 for carrying out the method according to any example described herein to modify a design 28 for the holographic structure 14. The control system 172 may include or be in the form of a computer program product that when executed by a processing system or control unit 174 of the control system 172 causes the processing system or control unit 174 to at least partially implement a method as claimed or described herein. The system 170 further includes a laser system 176 for modifying the material 12 according to the design 28. The control system 172 is operable to control the laser system 172, which in this example includes the laser system 32 described in relation to FIG. 3, such that the material 12 is modified to include the holographic structure 14 according to the design 28.

FIG. 20 illustrates a system 180 for determining an authenticity of a material 12 including a holographic structure 14 formed by the system 170 or any other appropriate system. The system 180 includes an inspection system 182 for inspecting a design 28 of the holographic structure 14 in a material 12. The inspection system 182 may include a microscope, phase contrast microscope, white light interferometer, stylus profilometer, atomic force microscope, or the like. The system 180 further includes a comparison system 184 for comparing the inspected design 28 with an expected design. If an inspection reveals that the holographic structure 14 in the material 12 includes features (e.g. craters and/or bumps, or the like) that do not correspond with the expected design (e.g. a design that is known to or calculated by an authorised user such as a manufacturer, dealer or repairer based on the identifier 74), then the material 12 may be identified as being fake, or at least may prompt further investigation. Optionally, the system 180 may include the control system 172 of FIG. 19 for carrying out the method according to any example described herein to modify a design 28 for the holographic structure 14 in order for the authorised user to calculate the expected design.

The comparison system 184 may include or be in the form of a computer program product that when executed by a processing system or control unit 186 of the comparison system 184 causes the processing system or control unit 186 to at least partially implement a method as claimed or described herein. The comparison system 184 may be operable to control or interact with the inspection system 182, e.g. via the control unit 186, such that the inspection system 182 can inspect the holographic structure 14 and send information regarding the holographic structure 14 to the comparison system 184.

It will be appreciated that any combination of phase values, whether positive and/or negative (e.g. corresponding to a lowered or raised feature, or the like) can be used for creating a map of features. It will also be appreciated that there could be any number of levels in the holographic structure, e.g. 2, 3, 4 or more levels, or the like.

It will be appreciated that features that produce a phase response may additionally or alternatively comprise features that produce an amplitude response. For example, any appropriate example described herein may be implemented, modified or otherwise adapted to be in the form of a phase-only, amplitude-only or phase-and-amplitude hologram. For example, any individual reference to a phase-only hologram may be implemented, modified or adapted to be in the form of an amplitude-only hologram or a phase-and-amplitude hologram. Any reference to amplitude may also refer to intensity. For example, an amplitude hologram may be referred to as an intensity hologram.

Where appropriate, any reference to a design, for example the design 28 described herein, may refer to a computer generated hologram (CGH) or vice versa. The design and/or CGH may be implemented in the form of the holographic structure 14, for example, using the laser system 176 or any other appropriate system for modifying the material 12. Where appropriate, any reference to a replica 20 may refer to a hologram and/or diffractive image and/or an image formed on the screen 24 or projected in the far-field. Where appropriate, the target image 22 may refer to a computer-generated image or CGH representative of the replica 20 expected to be projected. A person of ordinary skill in the art will appreciate that, where appropriate, references to any these terms may be modified or used in a different context.

At least one feature of any example of the present disclosure may be modified, combined with any other example, or otherwise adapted in any appropriate way.

Although examples of the present disclosure refer to a material 12 including the holographic structure 14, it will be appreciated that the material 12 may include or be in the form of any article such as a product, packaging, label, or the like.

Although examples of the present disclosure illustrate and describe a laser-based process for modifying a surface 58 of the material 12, it will be appreciated that an internal part of the material 12 or a product may be modified using an appropriate laser-based process, which may depend on the transparency of the material 12 (or a surface thereof) used.

Although examples of the present disclosure describe a simple visual check of the replica projected by the holographic structure by reflecting e.g. a laser beam from the surface of the holographic structure, it will be appreciated that similar principles may apply for a transmission-based visual check of the replica in the far field for e.g. a transparent material including the holographic structure. Thus, radiation transmitted through the holographic structure may form a replica of the target image in the far field, instead of (or as well as) a replica being projected by reflection from the holographic structure.

Although examples of the present disclosure describe a holographic structure for reflecting radiation to project a replica of the target image, it will be appreciated that the holographic structure may transmit radiation to project a replica of the image. The holographic structure may be at least partially transparent, which may allow incident radiation to be transmitted through the holographic structure to project the replica of the target image. It will be appreciated that a certain amount of radiation may be reflected as well as transmitted.

Although examples of the present disclosure describe various systems (e.g. systems 170 and 180, and the like), it will be appreciated that such systems may relate to or include at least one of: apparatus including at least one feature or element of any example of the present disclosure; methods including at least one feature or element of any example of the present disclosure; apparatus for implementing at least one method of the present disclosure; and the like.

Although examples of the present disclosure mainly describe various systems for representing the holographic design as a map of phase values, it will be appreciated that the technique can be extended entirely analogously to representing the holographic design as a map of amplitude values, or even a combination of phase and amplitude values.

For example, where a phase value or relative phase value may be represented by a refractive index value or difference in refractive index values, or by an optical length or difference in optical length, an amplitude value or relative amplitude value may be represented by a difference in surface scattering or absorption or a combination these. In this way, a similar amplitude hologram could be produced by replacing the phase referred to above with a grey scale, where a phase of π corresponds e.g. to black, and a phase of zero corresponds e.g. to white. Such a grey scale map could then be encoded onto the product by generating absorbing or scattering regions.

An example of an amplitude hologram is described in Wægaard et al, “High-resolution computer-generated reflection holograms with three-dimensional effects written directly on a silicon surface by a femtosecond laser”, Optics Express Vol. 19 pp. 3434-3439, the contents of which is hereby incorporated by reference in its entirety.

1-42. (canceled)

43. A method for forming a holographic structure in a material, the holographic structure being configured to project a target image in the far field under illumination of the holographic structure, the method comprising:
calculating a design for the holographic structure for projecting the target image;
modifying the design to encode an identifier within the holographic structure for projecting the target image; and
modifying the material by mapping features corresponding to the modified design into the material.

44. The method of claim 43, wherein the identifier encoded by the modified design is such that the identifier is substantially hidden, masked or otherwise substantially unidentifiable in the projected target image.

45. The method of claim 43, wherein at least one of calculating and/or modifying the design comprises using the identifier as part of an algorithm to calculate the modified design.

46. The method of claim 43, wherein calculating the design comprises calculating a map of phase and/or amplitude values for projecting the target image, wherein each feature of the design corresponds to one of the phase and/or amplitude values.

47. The method of claim 46, wherein modifying the design comprises calculating a map comprising at least one different phase and/or amplitude value such that the target image projected by the holographic structure based on the modified design is indistinguishable from the target image projected before modification of the design.

48. The method of claim 46, wherein calculating the map of phase and/or amplitude values for projecting the target image comprises: calculating a set or array of features that have associated phase and/or amplitude values for projecting the target image, wherein each feature is at a different position in the map, and each position in the map has one of at least two phase and/or amplitude values.

49. The method of claim 43, wherein at least one of: calculating; and modifying the design comprises:
obtaining an initial design of the holographic structure for projecting the target image; and selecting a different phase and/or amplitude value for at least one of the features to modify the design, the modified design projecting a target image that is indistinguishable from, or at least similar to, the target image projectable by the holographic structure corresponding to the initial design.

50. The method of claim 49, wherein the initial design (a) comprises a map of phase and/or amplitude values comprising at least one feature corresponding to the identifier; or (b) is a map of phase and/or amplitude values comprising at least one of: constant phase and/or amplitude values across at least part of the map; random phase and/or amplitude values across at least part of the map; and a defined pattern of phase and/or amplitude values across at least part of the map.

51. The method of claim 43, wherein the identifier comprises an initial seed for deterministically generating a map of the features for the design.

52. The method of claim 43, comprising selecting at least one portion of the design and swapping the selected portion(s) with at least one other portion of the design.

53. The method of claim 52, comprising verifying whether the modified design of the holographic structure is configured to project a target image that is indistinguishable from, or at least similar to, the target image projected by a holographic structure corresponding to the unmodified design.

54. The method of claim 52, wherein the selected portion and the at least one other portion are portions that, individually project substantially the same or similar target image but that comprise or represent maps that are at least partially different.

55. The method of claim 54, comprising generating the map comprised in or represented by the selected portion using a first seed and/or first number of iterations and generating the map comprised in or represented by said at least one other portion using a second, different seed and/or a second, different number of iterations.

56. The method of claim 43, comprising modifying the material by at least one of: (a) changing a level of a surface of the material; (b) modifying a refractive index of the material; and (c) using radiation to at least one of: melt, ablate, move, deposit, or otherwise distribute the material; and change a chemical property of the material.

57. A product comprising a holographic structure for projecting a target image in the far field under illumination of the holographic structure, the holographic structure comprising:
features based on a modified design that encodes an identifier within the holographic structure for projecting the target image, wherein the identifier encoded by the modified design is preferably such that the identifier is hidden, masked or otherwise unidentifiable in the projected target image.

58. A computer program product that when executed by a processing system or control unit causes the processing system or control unit to at least partially implement the method of claim 43.

59. A system for forming a holographic structure in a material, comprising:
a control system for carrying out the method of claim 43 to modify a design for the holographic structure; and
a laser system for modifying the material according to the design.

60. A method for determining an authenticity of a material comprising a holographic structure formed by the method of claim 43, the method comprising:
inspecting at least part of the holographic structure to determine a design of the holographic structure; and
comparing the inspected design with an expected design.

61. A computer program product that when executed by a processing system or control unit causes the processing system or control unit to at least partially implement the method of claim 60.

62. A system for determining an authenticity of a material comprising a holographic structure formed by the method of claim 43, comprising:
an inspection system for inspecting a design of the holographic structure; and
a comparison system for comparing the inspected design with an expected design.
